(19) United States
(12) Patent Application Publication
(10) Pub. No.: US 2008/0077651 A1
(43) Pub. Date: Mar. 27, 2008

(54) Information processing system with collaborating devices

(75) Inventors: Shih-Fong Lee, Yuanlin Town (TW); Wen-Fu Lee, Taipei (TW); Tsung-Yueh Cheng, Banqiao City (TW)

Correspondence Address: BIRCH STEWART KOLASCH & BIRCH, PO BOX 747, FALLS CHURCH, VA, 22040-0747, US

(73) Assignee: ONGRAND LIMITED

(21) Appl. No.: 11/515,044

(22) Filed: Sep. 5, 2006

(51) Int. Cl. G06F 15/16

(52) U.S. Cl. 709/203

(57) ABSTRACT

The information processing system containing four types of devices: a registration server, one or more information servers, one or more agent servers, and two or more collaborating devices that may be located on their respective private networks. The information servers are the sources of public information and publish their public information to the collaborating devices via the agent servers by the agent-based communication mechanism. For the collaborating devices, they can either play the role of a master control device or a federated device to the master control device. The master control device communicates with one or more its federated devices in order to gather private or confidential information via point-to-point communications.

### BACKGROUND OF THE INVENTION

1. Field of the Invention

The present invention relates to information processing, and more particular to an information processing system with collaborating devices for autonomous information retrieval and organization.

2. The Prior Arts

With the information available through the network grows at exponential rate, the problem people now face is not about finding information, but about organizing the information in a timely manner for decision making. Despite the advancement in computer and network technologies, most people still rely on manual processes to gather the information they need from various sources. For example, everyday when the stock market starts, a stock trader has to manually connect to various network sites for stock pricing, market news, his or her account balance at the same time. The trader then has to digest, filter, and organize the vast amount of information so as to make a timely buy/sell decision.

However, some of the information is confidential and is open to authorized users only. This confidential information is usually stored on a server in a private local area network (LAN). For information security, secured point-to-point communications has to be established between the user and the servers. These servers are usually located on a LAN behind a routing device providing network address translation (NAT).

Simply put, NAT is a technology translating private IP addresses with real LP addresses. In a private network, devices are assigned private IP addresses and they can communicate with each other within the private network using their private IP addresses. When an inside device on the private network communicates with an outside device on the Internet, the routing device supporting the NAT technology automatically substitutes the private IP address in the source IP address field of the data packets sent from the inside device with a real IP address and sends the packets to the outside device. On the other hand, when receiving packets from the outside device, the routing device substitutes the real IP address in the destination IP address field of the packets with the original private IP address and sends the packets to the inside device.

When two communicating devices are both on private LANs behind NAT routing devices, due to the foregoing address translation process, they are not engaging in real, physical point-to-point communications, but require the mediation of the routing devices. As such, there are technologies such as uPNP NAT being proposed to resolve this problem. Though most of the recent routers support uPNP protocol, the ADSL modems and most of the routers deployed a few years ago don't support uPNP protocol. This implies that extra cost of replacing old routers with new ones has to be paid from both parties.

uPNP allows a device on the private network to notify the routing device and to map a network port directly to a real IP address. This requires software detection and control from the communicating device. Moreover, the opening of a static network port allows packets with any source address to pass through the routing device or to use the routing device for retransmission. This would present a serious security threat. Therefore, an uPNP NAT network administrator has to be cautious in monitoring data packet and control user's authorization.

Another security problem in uPNP NAT is that the mapping relationship between multiple inside devices and the routing device can be easily altered. A hacker can easily falsify connecting path between computers which allow unauthorized user catching confidential information in uPNP NAT private network. Furthermore, uPNP allows a local device to interact with the local routing device but not the remote routing device. Therefore, a local device cannot penetrate the remote routing device directly, unless the information about the static port of the remote routing device is available in advance.

Another technology STUN proposed by Cisco™ allows a remote device to detect the static port of the local routing device so as to penetrate the local routing device. However, STUN is only available on a limited number of equipments. This is still not a complete solution. Additionally, the STUN technology creates a data transmission path between two devices through STUN routers. These two devices cannot initialize a communication between each other without informing STUN routers to start switching process. The STUN routers only support UDP protocol which does not check received data packets by checksum.

In addition to the problem of delivering confidential or private information over point-to-point communications, the distribution of public information to a large number of receiving devices, even though with no security concerns, presents other problems. IP multicast is one such technique which is widely used in commercial networks for file distribution, and in the financial sector for applications such as stock tickers. However, forwarding multicast traffic, particularly for two-way communications, requires a great deal of protocol complexity. On the other hand, there are a number of additional concerns such as the denial of service attacks that IP multicast enables. “Push” technology, also called server push or webcasting, is an internet-based content delivery system where information is delivered from a central server to a client computer based upon a predefined set of request parameters outlined by the client computer. Push technology differs from normal internet technology, which is based on “Pull” technology where a user has to request a web site through an internet browser. The most significant technical problem associated with the push technology is network overload on the server side or performance hindrance on the client side. Another shortfall is that many users find the information they receive is not as well-filtered as they had hoped. Moreover, when a receiving device is off-lined and is back on-lined again later, these technologies have no way to recover the information it misses.

### SUMMARY OF THE INVENTION

Accordingly, a primary objective of the present invention is to provide an information processing system in which a number of loosely-coupled devices collaborates to integrate, organize, and present various pieces of public and private information.

Another objective of the present invention is to provide a point-to-point communication mechanism which allows devices on their respective private networks behind NAT routing devices to conduct true, point-to-point communications using technology supported by existing routing devices for enhanced information security without adding significant cost of ownership.

Another objective of the present invention is to provide an agent-based one-to-many communication mechanism for a device to push information to remote device through a number of intermediate devices (i.e., agents) so as to reduce the consumed network bandwidth. According to the user's specification and requirement, a receiving device is able to resume information gathering from the intermediate devices from the point when it is disconnected from the network or when it is turned off. As such, the receiving device will not lose any vital information for decision making.

In order to accomplish the above objectives, the present invention provides an information processing system containing four types of devices: a registration server, one or more information servers, one or more agent servers, and two or more collaborating devices that may be located on their respective private networks. The information servers are the sources of public information and push their public information to the collaborating devices via the agent servers by the agent-based communication mechanism. For the collaborating devices, they can either play the role of a master control device or a federated device to the master control device. The master control device proactively activate one or more its federated devices in order to gather private or confidential information via point-to-point communications.

One of the major characteristics of the present invention lies in the adoption of the registration server as the “brain” and information repository for the control and coordination among the servers and devices of the information processing system. By requiring the devices and servers of the information processing to register in the registration server about their services, information requirements, and environment parameters, the agent-based one-to-many communications and point-to-point communications among the servers and devices can progress automatically.

Another major characteristics of the present invention lies in the adoption of the agent servers as push agents which publish information for the information servers to the receiving devices. On one hand, the agent servers significantly reduce the bandwidth consumption when a large number of receiving devices directly receive information from the information servers. With the configuration of the agent servers, a number of receiving devices receive information from the near-by agent server, instead of going all the way to the original information server. On the other hand, by storing the public information in the agent servers and with the information contained in the registration server, a back-on-lined receiving device is able to recapture the information it misses.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 is a schematic view of the collaborating devices of the information processing system according to the present invention.

FIG. 2 is a schematic view of an embodiment of the master control device according to the present invention.

FIG. 3 is a schematic diagram showing the point-to-point communications environment according to the present invention.

FIG. 4 is a schematic diagram showing a point-to-point communication method according to the present invention.

FIGS. 5A-5D are schematic diagrams showing the agent-based one-to-many communications mechanism according to the present invention.

FIGS. 6A-6C are schematic diagrams showing the agent-based one-to-many communications process according to the present invention.

FIG. 7 is a schematic diagram showing the process of picking up incomplete public information by a device.

### DETAILED DESCRIPTION OF THE PREFERRED EMBODIMENT

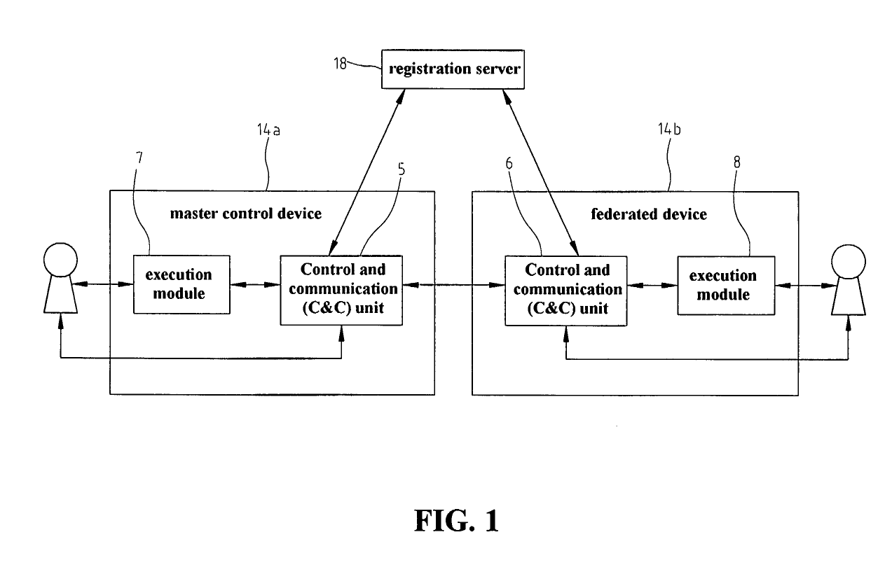

FIG. 1 is a schematic view of an information processing system according to the present invention. As shown in FIG. 1, an information processing system of the present invention contains a number of collaborating devices connected to a network (not shown). The term ‘device’ is used here to refer to a computing device such as a PC, a notebook computer, a server, or a large mainframe computer. They are referred to as ‘collaborating’ devices as they will collaborate in engaging two-way communications in gathering information for a user. From a user's point of view, the device that the user is using in gathering and presenting information to the user is referred to as a master control device (i.e., 14a). The other devices that respond to the master control device 14a's commands and communications are referred to as federated devices (i.e., 14b). A registration server 18 is provided so that the master control device 14a and the federated device 14b can communicate through NAT and the information processing system can function automatically. Please note that a federated device may not have the information requested by the master control device. However it may have the knowledge and capability to retrieve the required information and send the information back to the master control device. A possible scenario is that the federated device may itself be a master control device to request the required information from a second federated.

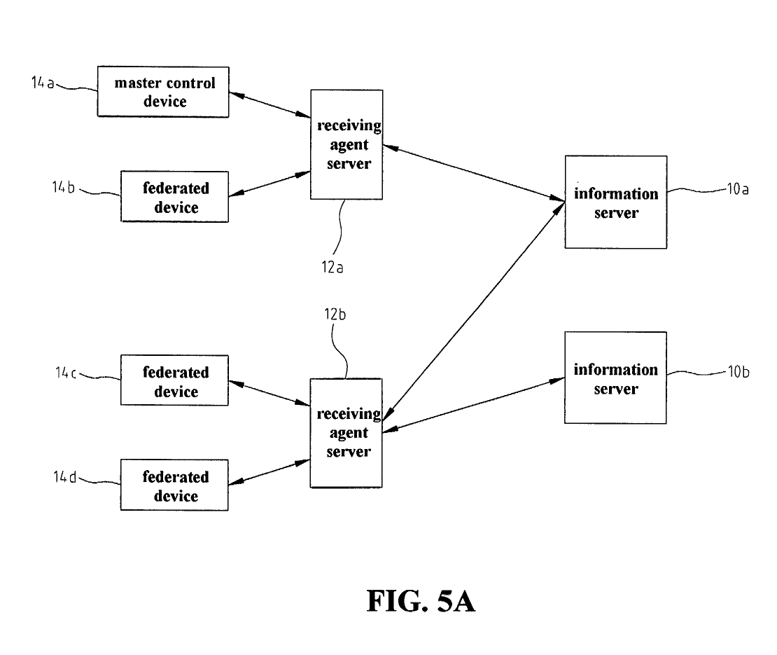

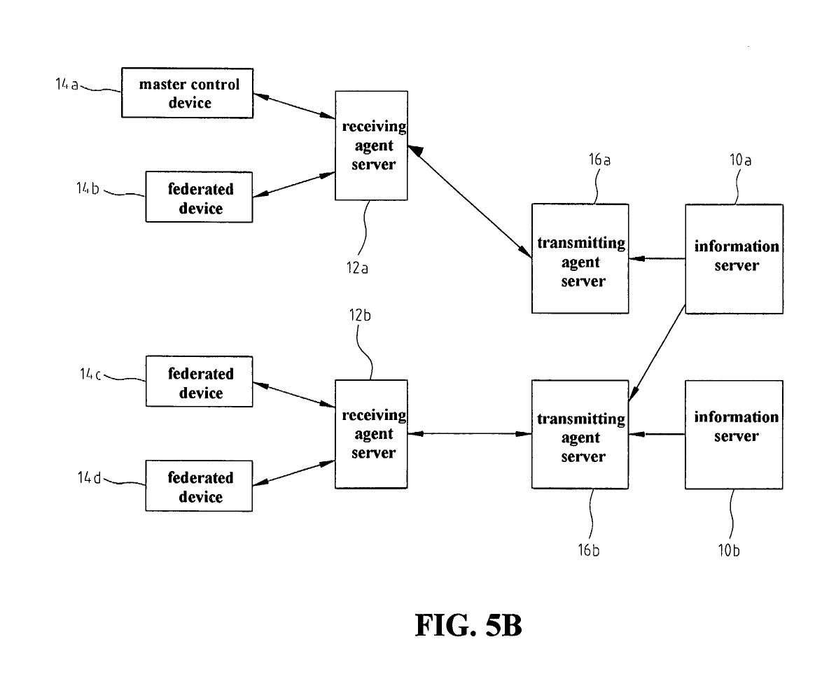

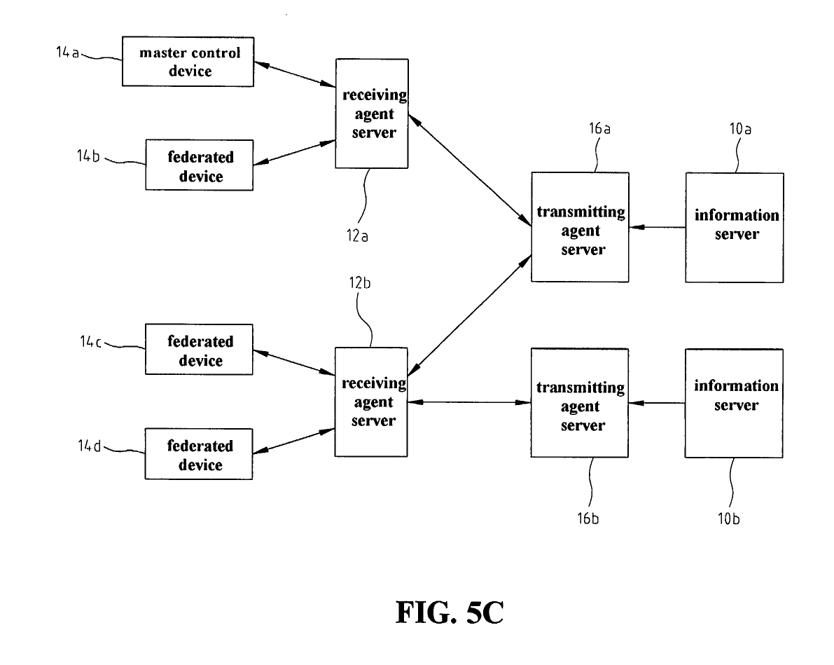

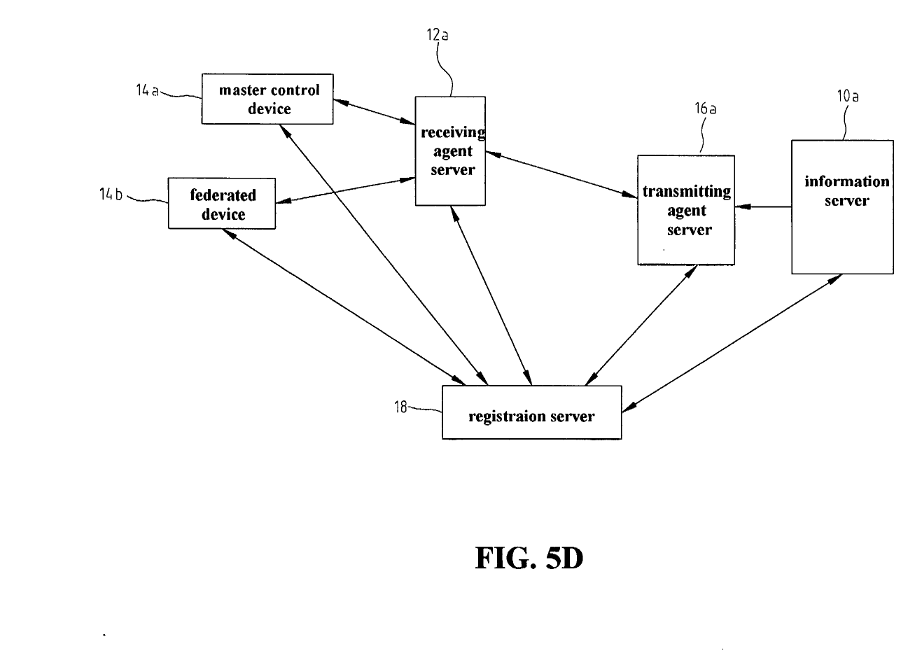

Basically, in the information processing system according to the present invention, a master control device 14a can activate the federated device 14b, and command this specific device to return required information to the master control device 14a. As such a user of the master control device 14a can easily gather confidential information he or she needs from the other devices. In order to achieve the foregoing mode of operation, the information processing system contains a point-to-point communication mechanism. As shown in FIG. 5A, the information processing system also contains one or more information servers 10a and 10b and one or more agent servers 12a and 12b so that any of the devices 14a˜14d can obtain public information from the information servers 10a and 10b through an agent-based one-to-many communication mechanism. In the following, these mechanisms will be described in details. Even though the term “server” is used, this is not to imply that the information servers or agent servers have to be server-class computers. They are referred to as servers as they constantly publish information to the devices, in contrast to the federated devices which provide information on demand.

As mentioned earlier, in the information processing system, a master control device 14a interoperates and collaborates with a federated device 14b to gather and process confidential information. In the mean time, the master control device 14a can receive public information from the information servers 10a and 10b. To conduct these communications, the master control device 14a must have a C&C (control and communication) unit 5 installed and executed. A federated device 14b also must have a C&C unit 6 to collaborate with the master control device 14a. Basically, the C&C units 5 and 6 have same functionality and ways of operation, except that one plays an active role while the other plays a passive role. A C&C unit is usually implemented as a resident service of the operating system running on the master control and federated devices. During the collaboration process, if required, the C&C unit 6 will invoke appropriate execution modules 8 to carry out the requests issued from the C&C unit 5. Similarly, the C&C unit 5 will invoke appropriate execution modules 7 to carry out the requests issued from the C&C unit 6 if necessary. The term “execution module” is used here to refer to independent software programs also installed on the same device as the C&C unit that can be activated by the C&C unit. An execution module could be another resident service of the operating system, an application program such as Microsoft® Word®, or an administration interface program of the C&C unit, just to name a few examples. The C&C unit can also be configured to activate certain execution modules when the C&C unit is started, or according to a schedule specified by the user. The interaction between the C&C unit and the execution module is loosely coupled and could be in a two-way manner. If an execution module is an application program, the execution module is activated by the C&C unit's calling the operating system's appropriate service. Some parameters can be passed to the activated execution module during its start-up. Once the execution module is activated, it is running as an independent process. Subsequently, the C&C unit can still interact with the execution module using appropriate mechanisms (such as Dynamic Data Exchange, DDE®) and information can be passed between the C&C unit and the execution module. A scenario of the interaction between the C&C unit and the execution module is as follows. A C&C unit receives three Word® document files and requests to open the three files from another C&C unit. The C&C unit first checks to see if the Word® program is already running; if yes, the C&C unit informs the Word® program to open the first Word® file at a specified directory; if not, the C&C unit activates the Word® program and instructs it to open the first Word® file at the specified directory. Subsequently, the C&C unit calls the running Word® program to open the second and third Word® files at the specified directory. After the three Word® files are opened, the C&C unit leaves the Word® program to run independently. The user then can operate the Word® program to view or edit the three Word® files.

It has to be stressed again that a device can be a master control device at one time and be a federated device to some other master control device at another time. Furthermore, a device can actually be, at the same time, both a master control device and a federated device. Therefore, a master control device can interoperate with more than one federated device, and one or more of the federated devices can further interoperate with their own federated devices. This is all achieved by the C&C units of these devices. Also through the C&C units, the master control device thereby can invoke an execution module in a federated device so as to gather the required information. Each device's C&C unit has a unique ID so as to distinguish one device from the other devices. The devices and servers conducts communications using messages expressed in an extensible language such as XML (eXtensible Markup Language). More details will be given later.

The C&C unit 5 of the master control device 14a gathers the required information from various sources specified in its service directories. There are two service directories in the C&C unit on a device: open service directory containing information about sources of open and public information, and proprietary service directory containing information about sources of private and confidential information.

As shown in FIG. 1, the C&C unit 5 of the master control device 14a, based on the information contained in its open service directory, activates and instructs the execution module 7 to retrieve public information (such as stock pricing) through the agent-based communication mechanism. Or, the C&C unit 5, based on the information contained in the proprietary service directory, activates and instructs the execution module 7 to retrieve confidential information (such as account balance) by invoking and communicating with the execution module 8 of the specific federated device 14b through the C&C unit 6 and the point-to-point communication mechanism. Both the public and confidential information is then collected and presented by the execution module 7 to the user of the device 14a.

As will be explained later, each information provider of the information processing system will register its service in a registration server where a list of all available information services is thereby compiled. Then, the list of information services is subsequently passed to a device for setting up the device's open service directory. The information contained in the open service directory contains sets of information or instructions called scripts. The scripts are categorized into fixed scripts, variable scripts, and control scripts, all expressed in an extensible language such as XML. These scripts direct the C&C unit to activate appropriate execution module of the master control device to conduct agent-based one-to-many communications in gathering open or public information. An example of a fixed script is as follows:

```
<script>
    <isid=1111 directory_id=98
    directory_name=”Instant Stock Price Index”/>
    <isid=9999 directory_id=99
    directory_name=”Stock Market News”/>
</script>
```

This fixed script specifies that (1) the Instant Stock Price Index information is published from an information server whose ID is 1111 under a directory ID 98. Similarly, the Stock Market News information is published from another information server whose ID is 9999 under a director ID 99. An example of a variable script is as follows:

```
<script>
    <isid=1111 directory_id=98
    directory_name=” Instant Stock Price Index”>
        <agentid=1515 agent_ip=”15.15.15.15”/>
        <agentid=3030 agent_ip=”30.30.30.30”/>
    </isid>
    <isid=9999 directory_id=99 directory_name=”Stock Market News”>
        <agentid=2020 agent_ip=”20.20.20.20”/>
        <agentid=3030 agent_ip=”30.30.30.30”/>
    </isid>
    <control/>
</script>
```

This variable script contains data about where to retrieve information and the data reflects the current network configuration (therefore, the name ‘variable’ script). In the example above, the variable script specifies that the Instant Stock Price Index information is available both from the agent servers whose IDs are 1515 (with an IP address 15.15.15.15) and 3030 (with an IP address 30.30.30.30). Similarly, the variable script also specifies that the Stock Market News information is available both from the agent servers whose IDs are 2020 (with an IP address 20.20.20.20) and 3030 (with an IP address 30.30.30.30). More details about the agent servers will be described later. On the other hand, the control script contains the instruction about how to retrieve specific information (therefore, the name ‘control’ script). An example of a control script is as follows:

```
<script>
    <cncid=9999/>
    <control>
        <subscribe>
            <isid=9999
            directory_id=99 directory_name=” Stock Market News”/>
        </subscribe>
    </control>
</script>
```

### This control script specifies the ‘command’ used in a message to subscribe Stock Market News information from the information server whose ID is 9999.

Similarly, the information contained in the proprietary service directory also contains scripts. There are only fixed scripts and control scripts in the proprietary service directory, which direct the execution module in the master control device to conduct point-to-point communications in gathering private information from federated devices. The proprietary service directory does not contain variable scripts as, for example, there is no agent servers involved in the point-to-point communications. An example of a fixed script of the proprietary service directory is as follows:

<script>
<cncid=1111 directory_id=97 directory_name=”Stock Account”/>
</script>

This fixed script specifies that private information Stock Account is available from a federated device whose C&C unit ID is 1111 under a directory ID 97. An example of a control script of the proprietary service directory is as follows:

```
<script>
    <cncid=9999/>
    <control>
        <subscribe>
            <cncid=1111 directory_id=97
            directory_name=” Stock Account”/>
        </subscribe>
    </control>
</script>
```

This control script specifies the ‘command’ used in a message to subscribe Stock Account information from the federated device whose C&C unit ID is 1111. In the following, the functions of the service directories will be described to explain how the point-to-point communications and agent-based one-to-many communications are conducted.

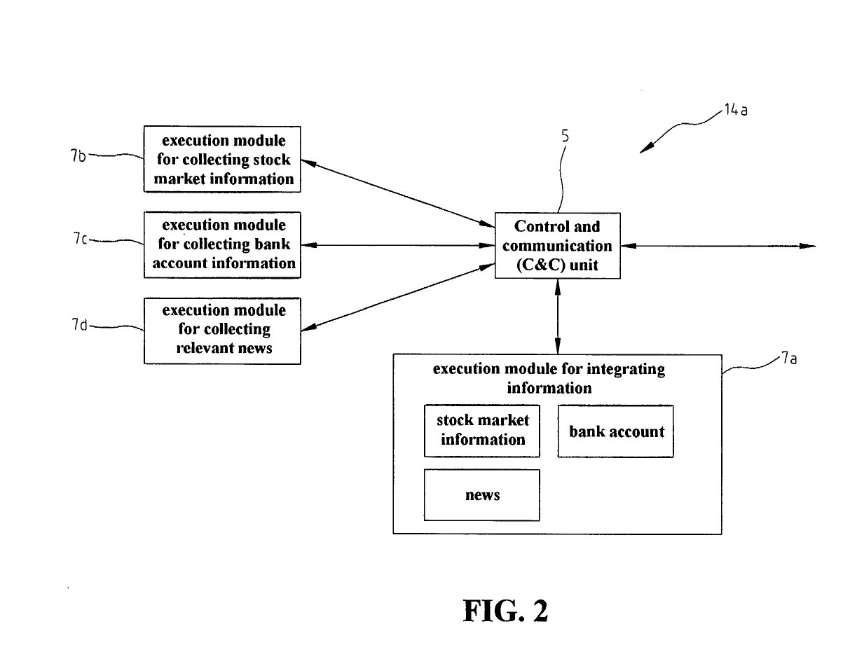

FIG. 2 is a schematic view of an embodiment of the master control device according to the present invention. As shown in FIG. 2, the master control device 14a invokes an execution module 7a for gathering and integrating information required by a user such as stock pricing information, the user's bank account information, and relevant market news. To gather these pieces of information, the C&C unit 5 invokes an execution module 7b for collecting stock pricing information, an execution module 7c for collecting bank account information, and an execution module 7d for collecting relevant market news.

For execution modules 7b and 7d, as the stock pricing information and market news are public information, they follow the scripts in the open service directory to retrieve these pieces of information. As to the execution module 7c, as the bank account information is private and confidential, it follows the scripts in the proprietary service directory to retrieve this piece of information.

FIGS. 5A-5D are schematic diagrams showing the agent-based one-to-many communications mechanism according to the present invention. As shown in FIG. 5A, the public information in the information processing system is distributed by at least an information server. In the diagram, two information servers 10a and 10b are depicted. In order to effectively and efficiently reduce the amount of network traffic and loading of the information server, the public information of the information servers 10a and 10b is distributed and stored on at least a receiving agent server (two receiving agent servers 12a and 12b are depicted in the diagram). As such, the devices 14a˜14d retrieve the public information from the receiving agent servers 12a and 12b, instead of directly from the information severs 10a and 10b, saving significant amount of network bandwidth.

It is also possible to have the receiving agent servers 12a and 12b to distribute public information proactively to the devices 14a˜14d via a distribution rule, instead of waiting for the requests from the devices 14a˜14d. As such, whenever the devices 14a˜14d get access to the network, they can start receiving public information from the receiving agent servers 12a and 12b. The distribution rule, based on a classification of the content of the public information and a ranking of the devices 14a˜14d, describes whether, when, and in what sequence, the public information is passed to the devices 14a˜14d. The advantage in saving network traffic and offloading the information servers will become significantly apparent when there are a very large number of devices.

As shown in FIG. 5A, as the number of receiving agent servers increases, the information servers will still be overloaded. To overcome this problem, the information processing system of the present invention can have at least a transmitting agent server (two transmitting agent servers 16a and 16b are depicted) positioned in the path between the information servers and the receiving agent servers. The function of the transmitting agent servers 16a and 16b is just like the receiving agent servers 12a and 12b. The difference lies only in that the transmitting agent servers 16a and 16b distribute public information to the receiving agent servers 12a and 12b, while the latter distributes to the devices 14a˜14d.

Therefore, dependent on network bandwidth and loading, the information processing system of the present invention can have architecture as depicted in FIG. 5B or 5C. For the former, the information server, say, 10a needs to know beforehand the address information about every retrieving agent servers while, for the latter, the information server needs to have the address information about the transmitting agent servers and let the transmitting agent servers to obtain address information about the receiving agent servers.

In the foregoing discussion, it is assumed that each of the servers and the devices has relevant information such as service provided and address about the other party it is communicating with in advance. For a very large network with hundreds or thousands of servers and devices, the management, distribution, and configuration of these pieces of information are very difficult, if not impossible. To overcome these problems, as shown in FIG. 5D, a registration server 18 is provided in the information processing system of the present invention. Basically, all the servers and devices of the information processing system register in the registration server 18 and the registration information (e.g., address information) is used to coordinate their intercommunications. In the following, how the public information is transmitted from the information sever to the device is described in details.

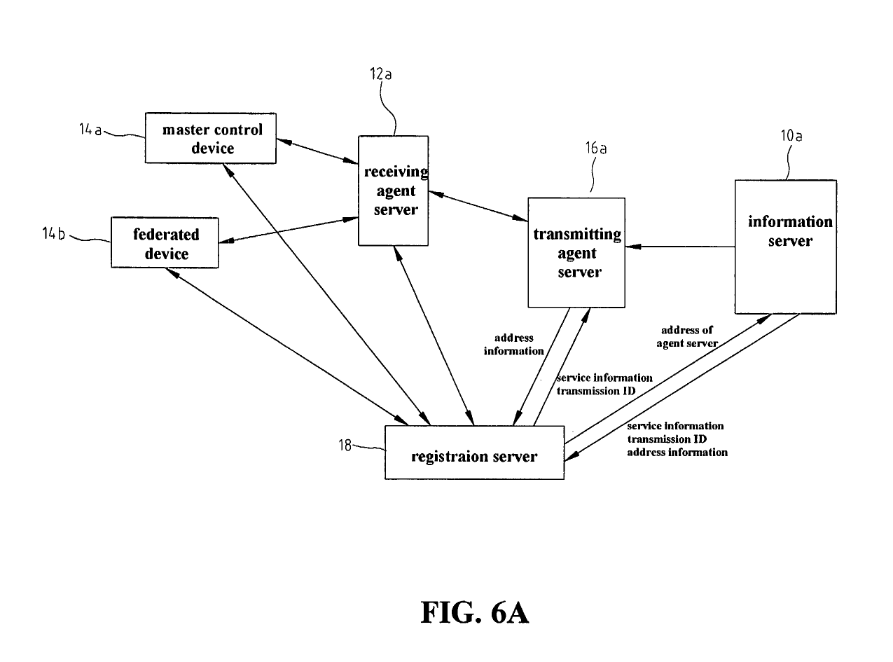

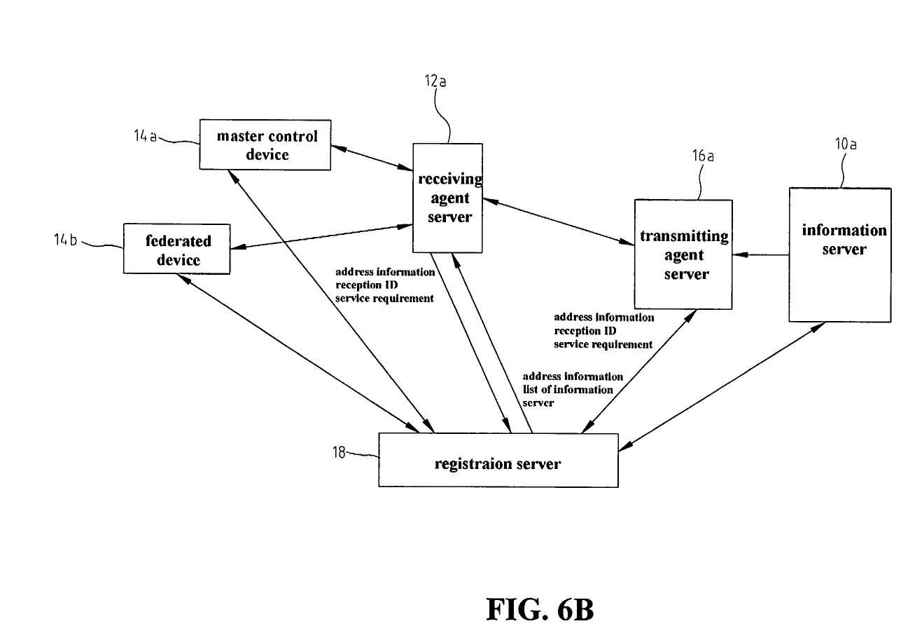

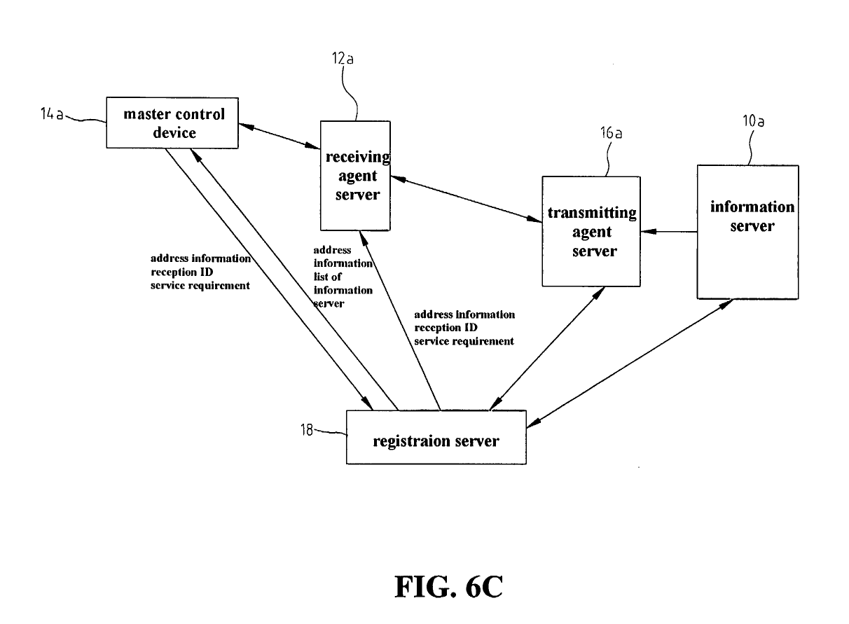

FIGS. 6A-6C are schematic diagrams showing the agent-based one-to-many communications process according to the present invention. As shown in FIG. 6A, when an information server 10a is started and gets access to the network, it automatically registers in the registration server 18 about its address, the information service it provides, and its server ID. On the other hand, when a transmitting agent server 16a is started and gets access to the network, it automatically registers in the registration server 18 about its address and its server ID (hereinafter, an agent ID). After that happens, the registration server 18 notifies the information server 10a about the address and agent ID of the transmitting agent server 16a, and the transmitting agent server 16a about the server ID and service of the information server 10a. As such, subsequently, the information server 10a is able to identify the transmitting agent server 16a and starts to distribute the public information to the transmitting agent server 16a automatically.

Similarly, when the receiving agent server 12a is started and gets access to the network, it too registers in the registration server 18 about its address, its agent ID, and the information service requirement. The registration server 18 again notifies the transmitting agent server 16a about the address, agent ID, and information service requirement of the receiving agent server 12a, and the receiving agent server 12a about the address and the list of information servers represented by the transmitting agent server 16a. As such, the transmitting agent server 16a is able to identify the receiving agent server 12a and starts to distribute the public information to the receiving agent server 12a. Please note that, during the foregoing process, the registration server 18 is able to know the public information services available in the information processing system and what transmitting and receiving agent servers are publishing a specific information service. Please also note that a transmitting or receiving agent server can publish for more than one information service.

A sample scenario about the process that a device obtains public information is described as follows, assuming that the device 14a has a C&C unit ID 9999. When the device 14a is started and gets access to the network, it will also register in the registration server about its address and C&C unit ID. If the device 14a requires subscribing a public information service, the device 14a sends a message to the registration server 18 for a list of information services. The message would contain a following script:

```
<script>
    <cncid=9999/>
    <control>
        <request>
            <directory_list/>
        </request>
    </control>
</script>
```

Upon receiving the message, the registration server 18 replies with a message containing the following script:

```
<script>
    <directory_list>
        <isid=1111 directory_id=98
        directory_name=”Instant Stock Price Index”/>
        <isid=9999 directory_id=99
        directory_name=”Stock Market News”/>
    </directory_list>
</script>
```

As mentioned earlier, these pieces of information are used to set up the fixed and control script of the device 14a's open service directory. Assuming that the device 14a would like to obtain Stock Market News and based on the fixed and control scripts of the open service directory, the device 14a sends a message containing the following script to the registration server 18:

```
<script>
    <cncid=9999/>
    <control>
        <subscribe>
            <isid=9999 directory_id=99
            directory_name=” Stock Market News”/>
        </subscribe>
    </control>
</script>
```

### The registration server 18 in turn sends a message containing the following script to the information server 10a providing the Stock Market News:

```
<script>
    <cncid=9999/>
    <control>
        <subscribe>
            <isid=9999 directory_id=99
            directory_name=” Stock Market News”/>
        </subscribe>
    </control>
</script>
```

If the information server 10a accepts the subscription, it replied with a message containing the following script:

```
<script>
    <isid=9999/>
    <control>
        <isid=9999 directory_id=99>
            <add cncid=9999/>
        </isid>
    </control>
</script>
```

Upon receiving this subscription notice, the registration sever 18 would perform a number of tasks: (1) registering that the device 14a has subscribed the Stock Market News from the information server 10a; (2) notifying the relevant receiving agent servers (e.g., 12a) about the address and C&C unit ID of the device 14a; and (3) notifying the device 14a by a message containing the following script:

```
<script>
    <isid=9999 directory_id=99 directory_name=”Stock Market News”>
        <agentid=2020 agent_ip=”20.20.20.20”/>
        <agentid=3030 agent_ip=”30.30.30.30”/>
    </isid>
    <control/>
</script>
```

This message is to let the device 14a know which receiving agent servers (2020 and 3030) is publishing the Stock Market News. These pieces of information are then stored in the variable scripts of the open service directory. In the mean time, the registration server 18 notifies the receiving agent server (e.g., 12a) about the address, C&C unit ID, and desired information service (by the directory_ID) the device 14a. As such, the receiving agent server 12a is able to identify the device 14a and starts to distribute the public information to the device 14a. Please note that, by incorporating appropriate control in the subscription message, various types of subscription can be achieved. There could be a one-time subscription where the subscription is cancelled automatically after the information is delivered to the device 14a. To receive the information again, the device 14a has to make another subscription as described above. The subscription can also be limited to a number of times of the information delivery; or the subscription can remain valid until being cancelled by the device 14a. Please also note that the information server 10a can reject a subscription or alter the type of the subscription. While the subscription is still valid, information about the subscription will be kept at the C&C unit of the device 14a, the information server 10a, and the registration server 18 and, whenever new information is produced on the information server 10a, the new information is delivered according to what is specified in the fixed and control scripts.

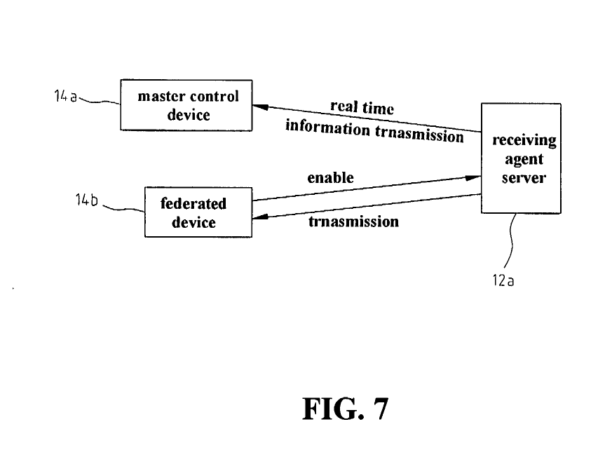

As the devices may be turned on and off, it is very possible that a device didn't receive complete public information. The solution to the problem is as follows. FIG. 7 is a schematic diagram showing the process of picking up incomplete public information by a device. As shown in FIG. 7, a receiving agent server 12a continues to provide real-time information transmission to device 14a. When an off-lined device 14b is started and gets access to the network, it registers in registration server 18. As described earlier, it will obtain information about the receiving agent server 12a. The device 14b therefore sends a message with a file ID of the incomplete transmission to the receiving agent server 12a (denoted as “enable” in the diagram), and the receiving agent server 12a then directly transmits remaining data to the device 14b without requesting the original information server 10a (denoted as “transmission” in the diagram). In other words, the devices are not required to be always on-line in order to receive public information. If the transmission is interrupted for any reason, the lost information can be recovered the next time when the device gets back on-line. Please note that, in the foregoing description, it is assumed that the public information is stored in files and each file has an unique ID. However, the implementation is not limited to files only.

The proprietary service directory is established via a similar process. For example, assuming that a device (e.g., 14b with a C&C unit ID 3333) provides confidential ROI (return on investment) Expectation Value information and when the device is started, it too registers the information provision in the registration server by a messaging having the following script:

```
<script>
    <cncid=3333/>
    < directory_list >
        <cncid=3333 directory_id=96
        directory_name=”ROI Expectation Value”/>
    </ directory_list >
</script>
```

This message may also contain other information such as which device (e.g., 14a) can obtain this confidential information. Please note that this information service will be delivered to the device requesting the list of information server as well, along with other public information services as described earlier. However this piece of information is stored in a fixed script of the proprietary service directory, instead of the open service directory. Assuming that the device 14a would like to obtain the confidential information, it issues a message having the following script to the registration server:

```
<script>
    <cncid=9999/>
    <control>
        <subscribe>
            <cncid=3333 directory_id=99
directory_name=”ROI Expectation Value”/>
        </subscribe>
    </control>
</script>
```

### Again, the registration server relays the subscription request to the device 14b. If the device 14b replies to accept the subscription, the registration server then provides the address of the device 14b to the device 14a, as described earlier.

In other words, whenever there is a new information service available on the network, the new information server or device registers in the registration server which in turn pass this information to the rest of the network. The establishment of the open and proprietary service directories in each of the devices is achieved by each device and each information server registering in the registration server, and the registration server in turn distributes the service information to the agent servers and the devices as described above. Each of the devices, upon obtaining this new service information, is able to set up the fixed and control scripts for receiving new public information from the new information server or confidential information from the device. On the other hand, variable scripts in open service directory contain parameters that are dynamically updated to reflect the current status of the information processing system. For example, there may be various number of receiving agent servers and each one may have different workload. As such, when a device is started and registers to the registration server, the registration server is able to designate a receiving agent server based on the loading condition of the receiving agent servers. Upon receiving this new information, the device is able to update the parameters of the variable scripts. As the variable scripts are designed for public information, the proprietary service directory does not contain variable scripts.

The control script contains information about how to obtain a specific information service. The control script may be C&C unit ID of the federated device providing the private information, the schedule to gather the private information, which one of the execution modules is responsible for gathering the private information, whether to display pop-up messages when they come in, and whether to share the information obtained. As described, a user of a device can “subscribe” a public information service provided by an information server. Then, corresponding scripts are prepared in the open service directory of the device. When the execution module 7b and 7d are invoked, they follow the scripts in the open service directory to gather the subscribed public information (such as the stock pricing and the market news) and pass the gathered information to the execution module 7a. In turn, the execution module 7a presents the gathered information on a display for the user to view. Similarly, when private information is required, the execution module 7c is invoked, which follows the scripts in the proprietary service directory to conduct point-to-point communications with the federated device 14b. The gathered information is also passed to the execution module 7a for presentation to the user. All the foregoing flexibility is the result of the use of scripts and service directories in the devices.

The use of scripts can be very powerful and versatile. For example, a device may send a control script to its federated device which instructs the federated device to perform a specific task. In addition, the scripts of a federated device can be updated dynamically so that the federated device would behave differently. Based on the same principle, the registration server can do more than just relaying messages. For example, upon receiving a subscription message for Instant Stock Price Index, the registration server may request further subscriber information from the device:

```
<script>
    <cncid=9999/>
    <control>
        <subscribe>
            <isid=1111 directory_id=99
directory_name=”Instant Stock Price Index”/>
            <form>
                <input type=”text” name=”name” value=”Max”>
                <input type=”text” name=”account”
                value=”27058167”>
                <input type=”text” name=”branch”
                value=”Taipei Office”>
                <input type=”text” name=”AE”
                value=”Sales Person”>
            </form>
        </subscribe>
    </control>
</script>
```

In this example, a form with a number of fields (with default values) will be presented on the device's display. After a user has keyed in the required data, the data will be returned to the registration server for further processing (e.g., forwarding to the information server).

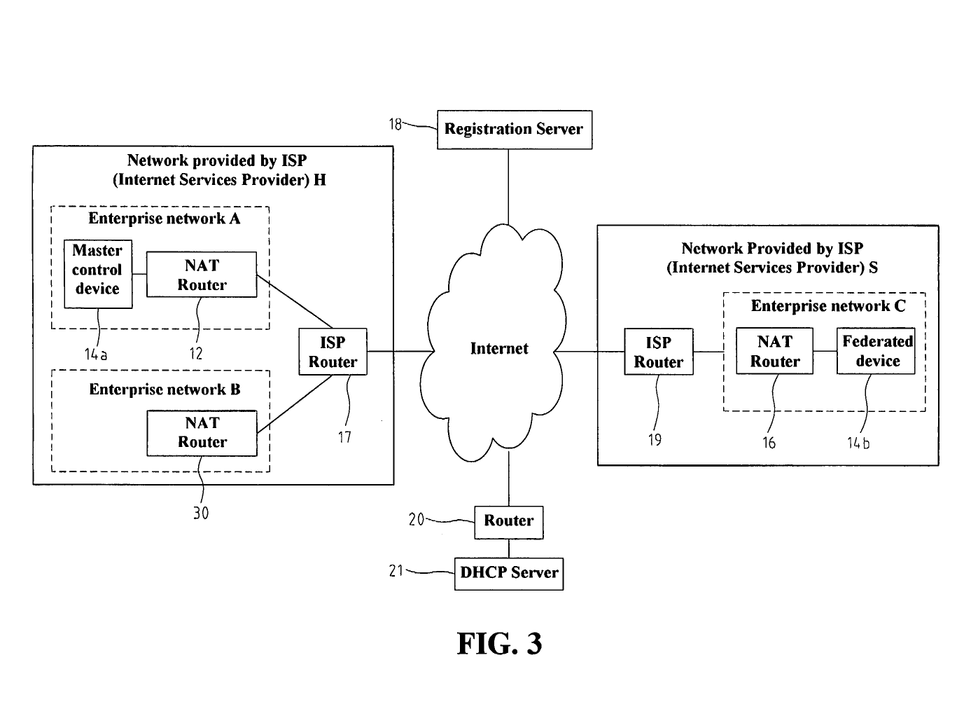

In real-life environment, a master control device 14a requiring the private information and a federated device 14b (such as a server of a bank) providing the private information may very possibly both access the network via NAT, as shown in FIG. 3. As shown in FIG. 3, a master control device 14a is on an enterprise network A connected to the Internet via ISP (Internet Services Provider) H, and a federated device 14b of the master control device 14a is on an enterprise network C connected to the Internet via another ISP S. As shown, the master control device 14a has a private IP address and access the network through a NAT router 12, and a federated device 14b also has a private IP address and access network through a NAT router 16. The data packets are transmitted between the master control device 14a to its federated device 14b via the NAT router 12, ISP H's ISP router 17, ISP S's ISP router 19, and the NAT router 16.

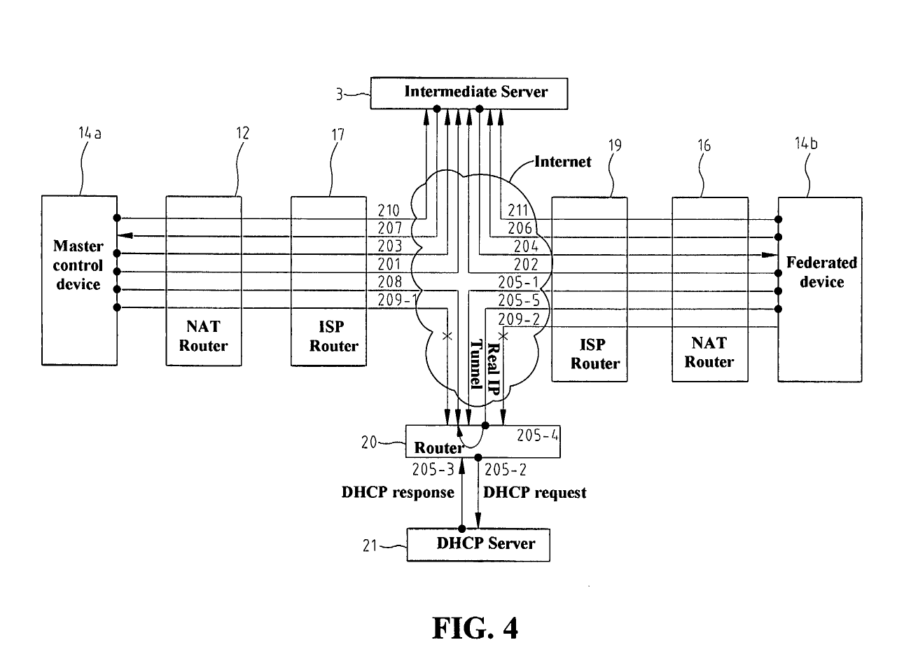

To allow the master control device 14a and the federated device 14b to conduct point-to-point communications with each other, a solution is provided as follows. FIG. 4 is a schematic diagram showing a point-to-point communication method according to the present invention. As shown in FIG. 4, the master control device 14a first establishes a session with an intermediate server 3 and registers its IP address along with other relevant information in the intermediate server 3 in step 201. Please note that the session is still maintained by the master control device 14a. Then, in step 202, the federated device 14b also establishes a session with the intermediate server 3 and registers its IP address along with other relevant information in the intermediate server 3. Again, this session is still maintained by the federated device 14b. Please also note that, during the above two sessions, the intermediate server 3 is able to detect the network environments (e.g., whether NAT is used or not) of the master control and federated devices 14a and 14b and to collect relevant information. The intermediate server 3 could be the registration server 18, or it can be a separate server. The intermediate server 3 contains a routing unit and a decision unit (both not shown) whose function will be described as follows.

During the foregoing registration process, the decision unit in intermediate server 3 can compare address information contained in the data and header of the packets sent from the master control and federated devices 14a and 14b. If the addresses in the header and data sections of the packets are identical, the decision unit can decide that the device does not access network through NAT. If the decision unit decides that any one of the devices 14a and 14b is not behind NAT, the intermediate server 3 can provide a conventional point-to-point communication path for the devices 14a and 14b. If the decision unit decides that master control device 14a and federated device 14b both access network through NAT, the intermediate server 3 starts a communication mechanism of the present invention. According to the present invention, at least one of the ISP routers 17, 19 should have the capability supporting the tunneling technology, or a third party router 20 (shown in FIG. 3) supporting the tunneling technology can be used. The tunneling technology includes the supports for the following network protocols: Generic Routing Encapsulation tunneling (GRE tunneling), Internet Protocol Security (IP Sec), Point to Point Tunnel Protocol (PPTP) and Layer Two Tunneling Protocol (L2TP) or Layer Two Forwarding (L2F). Additionally, according to the present invention, the intermediate server 3 should have information about these routers and the DHCP servers associated with these routers.

In step 203, the master control device 14a sends a message to the intermediate server 3 through the maintained session requesting to engage in point-to-point communication with the federated device 14b. The decision unit of the intermediate server 3 decides how the point-to-point communications should be conducted according to the foregoing description. The decision unit of the intermediate server 3 will decide a router which supports the tunneling technology. This router could be the ISP router 17 or the ISP router 19 or the router 20. In the following, it is assumed that the router 20 is picked. Then, in step 204, the routing unit of the intermediate server 3 notifies the federated device 14b through the maintained session about the router 20 and the DHCP server 21 associated with the router 20. Upon receiving the notification, the federated device 14b creates a communication tunnel with the router 20 and obtains a real IP address from the associated DHCP server 21 in step 205. More specifically, the step 205 contains the following steps. In step 205-1: a tunnel is established between the federated device 14b and the router 20; in step 205-2, the router 20 requests a real IP address from the DHCP Server 21; in step 205-3, the DHCP Server 21 allocates and returns the real IP address back to the router 20; and in step 205-4, the router 20 establishes two-way packet transmission between the real IP address and the tunnel.

After creating a communication tunnel to the router 20 and obtaining a real IP address, the federated device 14b reports the real IP address to the routing unit of the intermediate server 3 in step 206 again through the maintained session. Please note that the real IP address will be released after the disconnection of the communication tunnel when the point-to-point communication is over.

In turn, the routing unit of the intermediate server 3 informs the master control device 14a of federated device 14b's real IP address in step 207. The master control device 14a then conducts a point-to-point communications with the federated device 14b using the real IP address as destination address in step 208. As described, the present invention utilizes the existing capability (mainly the tunneling technology) of routers 17 or 19 or 20 to allow true point-to-point communications between the master control device 14a and the federated device 14b. As the private information is passed through highly secured tunnels established therebetween, the present invention not only enables true point-to-point communications but also provides high information security. To further enhance data security, for example, tunnels can also be established between the master control device 14a and the router 20, so that the entire path of the private information is through tunnels all the way between the master control device 14a and the federated device 14b. Please note that, to achieve this function, the master control device 14a requires a real IP address as well.

The routing unit in the intermediate server 3 plays an important role in the process. In addition to providing the real IP address for establishing tunnels, it will also monitor the router status and response time through which the tunnel is established by the C&C units of the collaborating devices. Additionally, it can collect traffic statistics through the tunnels for future billing. When the point-to-point communication is over, the federated device 14b disconnects the tunnel to the router 20 and the real IP address is released in step 209. In the mean time, the master control device 14a notifies the routing unit of the intermediate server 3 about the conclusion of the point-to-point communication through the maintained session in step 210. The session could still be maintained by the master control device 14a for future usage. Similarly, the federated device 14b also notifies the routing unit of the intermediate server 3 about the termination of the point-to-point communication through the maintained session in step 211. This session can also still be maintained by the federated device 14b for future usage.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. An information processing system comprising:
a network;
at least a device on said network, said device having a C&C unit, at least an execution module, and an open service directory, said open service directory having at least a fixed script, a variable script, and a control script;
at least an information server on said network, said information server providing at least an information service, each said information service distributing a set of information to at least a said device subscribing to said information service;
at least a receiving agent server on said network, said receiving agent server relaying at least a said set of information from a said information service to a said device subscribing to said information service; and
a registration server on said network, said registration server having a list of available information services, a list of receiving agent servers relaying for each said information service; and address information about all said servers and said devices;
wherein said fixed script and said control script of said open service directory are established by said C&C unit based on said list of available information services provided to said device by said registration sever; said fixed script specifies which said information service is available from which said information server, said control script specify how said C&C unit make subscription to said information service;
said variable script of said open service is established by said C&C unit based on said list of receiving agent servers provided to said device by said registration sever;
said C&C unit communicates with said registration server following said fixed and control scripts to make a subscription to a said information service;
said C&C unit communicates with at least a said receiving agent server following said variable script to received said set of information from a said information service; and
said execution module is invoked by said C&C unit in response to an appropriate trigger to process said set of information delivered to said device.

2. The information processing system according to claim 1, wherein said variable script of each said device is updated by said C&C unit of said device in response to said list of receiving agent servers of a said information service dynamically distributed to said device by said registration server.

3. The information processing system according to claim 1, wherein said subscription is forwarded to said information server by said registration server; and said information server is capable of accepting or rejecting said subscription.

4. The information processing system according to claim 1, wherein said subscription is for a fixed number of times of delivery of said set of information from said information server.

5. The information processing system according to claim 1, wherein said subscription is for an indefinite number of times of delivery of said set of information from said information server until said subscription is cancelled by said device.

6. The information processing system according to claim 1, wherein said scripts of said open service directory are expressed in an extensible language.

7. The information processing system according to claim 1, further comprising at least a transmitting agent server on said network, said transmitting agent server relaying at least a said set of information from a said information service to at least a said receiving agent server;
wherein said registration server has a list of transmitting agent servers relaying for each said information service.

8. The information processing system according to claim 1, wherein, in response to a said receiving agent server's registration to said registration server, said registration server notifies said receiving agent server about which said information server to retrieve said set of information of a said information service; and said registration server notifies said information server about which said receiving agent server to distribute said set of information.

9. The information processing system according to claim 7, wherein, in response to a said transmitting agent server's registration to said registration server, said registration server notifies said transmitting agent server about which said information server to retrieve said set of information of a said information service; and said registration server notifies said information server about which said transmitting agent server to distribute said set of information.

10. The information processing system according to claim 9, wherein, in response to a said receiving agent server's registration to said registration server, said registration server notifies said receiving agent server about which said transmitting agent server to retrieve said set of information of a said information service; and said registration server notifies said transmitting agent server about which said receiving agent server to relay said set of information.

11. The information processing system according to claim 1, wherein said appropriate trigger is one of the following: the instruction of a user of said device; a schedule of said C&C unit, and a message received by said C&C unit.

12. An information processing system comprising:
a network;
a plurality of devices on said network, each said device having a C&C unit and at least an execution module, a master control device among said plurality of devices having a proprietary service directory having at least a fixed script and a control script;
at least a routing device having the capability of establishing tunnels to said devices and assigning real IP addresses;
a registration server on said network, said registration server having a list of available information services registered by at least a federated device among said plurality of devices; and
an intermediate server capable of determining whether said master control and federated devices are behind NAT and assigning a said routing device as a relay between said master control and federated devices;
wherein said fixed script and said control script of said proprietary service directory are established by said C&C unit based on said list of available information services provided to said master control device by said registration sever; said fixed script specifies which said information service is available from which said federated device; said control script specify how said C&C to retrieve information from said federated device;
said C&C unit of said master control device communicates with said C&C unit of said federated device following said fixed and control scripts through a point-to-point communication path;
said execution module is invoked by said C&C unit of a said device in response to an appropriate trigger; and
said execution module of said master control device exchanges information with said execution module of said federated device via said point-to-point communication path.

13. The information processing system according to claim 12, wherein said intermediate server and said registration server are in a same physical device.

14. The information processing system according to claim 12, wherein said fixed and control scripts of said proprietary service directory are expressed in an extensible language.

15. The information processing system according to claim 12, wherein said appropriate trigger is one of the following: the instruction of a user of said device; a schedule of said C&C unit, and a message received by said C&C unit.

16. The information processing system according to claim 12, wherein, if at least one of said master control and federated devices is behind NAT, said point-to-point communication path goes through a said routing device specified by said intermediate server; and at least a tunnel is established between said device behind NAT and said routing device.

17. The information processing system according to claim 16, wherein said tunnel is established by the request of said device behind NAT to said routing device; and the other said device communicates with said device using a real IP address assigned by said routing device.
